(19) United States
(12) Patent Application Publication
(10) Pub. No.: US 2011/0161113 A1
(43) Pub. Date: Jun. 30, 2011

(54) INTERPRETIVE REPORT GENERATION

(75) Inventors: Leszek P. Rumak, Dunedin, FL (US); Grzegorz Kumik, Palm Harbor, FL (US); Karen MacLennan, Palm Harbor, FL (US); Michal Madera, Niechobrz (PL); Pawel Gancarz, Zabajka (PL)

(73) Assignee: SOFT COMPUTER CONSULTANTS, INC., Clearwater, FL (US)

(21) Appl. No.: 12/977,814

(22) Filed: Dec. 23, 2010

Related U.S. Application Data
(60) Provisional application No. 61/290,237, filed on Dec. 27, 2009.
(60) Provisional application No. 61/320,785, filed on Apr. 5, 2010.

(51) Int. Cl. G06Q 50/00

(52) U.S. Cl. 705/3

(57) ABSTRACT

An information processing system, a computer-readable storage medium, and a method are provided in which computer-readable instructions can be executed by processor. The method can include gathering data conditionally from a plurality of structured data sources in accordance with rules of a template. The gathered data may relate to a plurality of medical tests of a patient performed in accordance with one or more orders of tests. One or more of the rules of the template can conditionally select first data relating to a result of at least one of the medical tests based on one or more criteria. For example, a rule can conditionally select data based on at least one of: the existence of a given medical condition of the patient expressed by a clinical indication, an out-of-range result obtained on at least one of the plurality of medical tests, an out-of-range result obtained on another medical test of the patient being a medical test other than the plurality of medical tests, an out-of-range result obtained on a medical test of a probant being a person other than the patient, the existence of a given medical condition in a pedigree of the patient, or the existence of a given medical condition in the pedigree of the patient and an out-of-range result obtained in at least one medical test. A report can be generated in accordance with the gathered data and at least one rule of the template, the report summarizing a disease state of the patient.

### CROSS-REFERENCE TO RELATED APPLICATIONS

This application claims the benefit of the filing dates of U.S. Provisional Application Nos. 61/290,237 filed Dec. 27, 2009 and 61/320,785 filed Apr. 5, 2010, the disclosures of which are incorporated by reference herein.

### BACKGROUND OF THE INVENTION

1. Field of the Invention

The subject matter of the present application relates to processing of medical information, and more specifically, to a method, information processing system, and computer-readable recording medium for generating a report summarizing a disease state of a patient.

2. Description of Related Art

Medical information processing systems are commonly employed to track medical tests performed for diagnosing and treating a patient. Separate information processing systems are often required to track the progress and results of different types of tests and imaging, e.g., magnetic resonance imaging (“MRI”), computed tomography (“CT”), and X-rays, which may be performed for a given patient. Not only a number of distinct and different computer systems can be required to capture the results of the tests and imaging, distinct computer systems may be required to maintain the test results or imaging available in repositories after they are created. Because of this, it can be difficult to gather and summarize test results from the distinct and different computer systems. Typically, there is no automated way to summarize the results of multiple different types of tests or imaging performed relative to a particular patient so as to automatically generate a comprehensive report using the results of the different tests or imaging.

### SUMMARY OF THE INVENTION

An information processing system, a computer-readable storage medium, and a method are provided in which computer-readable instructions can be executed by processor. An information processing system can include a processor and a plurality of instructions which are executable by the processor to perform such method. A computer-readable storage medium may include instructions which are executable by the processor to perform such method. The method can include gathering data conditionally from a plurality of structured data sources in accordance with rules of a template. The gathered data may relate to a plurality of medical tests of a patient performed in accordance with one or more orders of tests. One or more of the rules of the template can conditionally select first data relating to a result of at least one of the medical tests based on one or more criteria. For example, a rule can conditionally select data based on at least one of: the existence of a given medical condition of the patient expressed by a clinical indication, an out-of-range result obtained on at least one of the plurality of medical tests, an out-of-range result obtained on another medical test of the patient being a medical test other than the plurality of medical tests, an out-of-range result obtained on a medical test of a probant being a person other than the patient, the existence of a given medical condition in a pedigree of the patient, or the existence of a given medical condition in the pedigree of the patient and an out-of-range result obtained in at least one medical test. A report can be generated in accordance with the gathered data and at least one rule of the template, the report summarizing a disease state of the patient.

The method can operate in various ways, which can be reflected in the information processing system or the computer-readable storage medium in like manner, as further described herein. For example, in one embodiment, the conditionally gathering of data can select the first data based on the existence of a medical condition of the patient expressed by a clinical indication.

In one way of operating, the conditionally gathering of data can select first data including cytogenetics data when the medical condition of the patient is of a predetermined class of medical conditions. In a particular form of operating, the conditionally gathering of data can select the first data based on an out-of-range result obtained on another medical test of the patient being a medical test other than the plurality of medical tests.

In a particular form of operating, the conditionally gathering of data can select the first data based on a marker result of a flow cytometry test being outside of a predetermined range, wherein the first data includes a karyotype image and includes an interpretative textual segment specific to the marker result. In a particular form thereof, the generating of the report can generate the report to include the karyotype image and results of the flow cytometry test in a textual segment in a predetermined location of the report.

In particular form of operating, the conditionally gathering of data can select the first data based on an out-of-range result obtained on a medical test of a probant being a person other than the patient.

In still another form of operating, the conditionally gathering of data can select the first data based on the existence of a given medical condition in a pedigree of the patient.

In one way of operating, the conditionally gathering of data can select the first data based on the existence of a given medical condition in the pedigree of the patient and an out-of-range result obtained in at least one medical test. In a particular form thereof, the conditionally gathering of data can select the first data based on the existence of the given medical condition in the pedigree of the patient and an out-of-range result obtained in at least one medical test of the patient. For example, the conditionally gathering of data can select the first data based on the existence of the given medical condition in the pedigree of the patient and an out-of-range result obtained in at least one medical test of a probant, the probant being a person other than the patient.

In accordance with another aspect of the invention, a method is provided for collaboratively preparing a report summarizing a disease state of a patient. Such method can include using at least one processor to execute a plurality of instructions to perform a set of steps. An information processing system can include a processor and a plurality of instructions which are executable by the processor to perform such method. A computer-readable storage medium may include instructions which are executable by the processor to perform such method. The steps can include displaying first content on a screen at a first information processing system to a first user, the displayed content including editable information for selecting data sources and data for inclusion in the report. The steps can include permitting the first user to select at least one second user to review the content displayed on the screen. The method may include a step of establishing a connection between the first information processing system and at least one second information processing system. The method can include a step of displaying first content on a screen at the at least one second information processing system to at least one second user. The method can also include permitting a user selected from the first user and the at least one second user to obtain a leader token. A step of permitting a user selected from the first user and the at least one second user to obtain a volunteer token can be a part of the method, and the method can include restricting editing of the editable information to only the user or the users who currently hold at least one of the leader token or the volunteer token. Such method can include restricting editing of the editable information to only one of the first or at least one second information processing apparatus at a time whose user holds such token. The screen at any other information processing apparatus besides the one information processing apparatus being used to edit the editable information can display the editable information in a form non-editable by a user at the any other information processing apparatus.

In accordance with such aspect of the invention, in such method, if the user who holds the volunteer token fails to use the volunteer token within a period of time having a predetermined duration, the token becomes available for any of the users to hold and use to edit the editable information.

In accordance with another aspect of the invention, a method is provided for generating a report summarizing a disease state of a patient, the method including using at least one processor to execute a plurality of instructions. An information processing system can include a processor and a plurality of instructions which are executable by the processor to perform such method. A computer-readable storage medium may include instructions which are executable by the processor to perform such method. Such method may include a step of generating a template having a set of rules for constructing the report, wherein the rules select one or more structured data sources from a plurality of data sources and select data from among a plurality of data contained in the one or more selected data sources, and generating the report summarizing the disease state of the patient, the report including data regarding the patient collected from the one or more data sources selected according to the rules of the template.

In a particular form of such method, the step of generating the report can include collecting data in the report contains data provided from at least one item selected from the group consisting of: a) a plurality of test orders, b) a plurality of test results; or c) a plurality of applications which have access to at least some of the data regarding the patient.

The method may further include displaying the collected data at a workstation, and the step of generating the report can include collecting data from at least one data source remote from the workstation.

In one embodiment, the collecting of the data can be performed by at least one processor remote from the workstation executing a query instruction.

The step of displaying the collected data can include displaying a report which contains (i) data identifying a patient; (ii) data identifying a diagnosis; and (iii) a statement written by a medical professional regarding the current disease state of the patient.

In a particular form of the method, the step of generating the template can be performed by at least one processor remote from the workstation.

In one embodiment, the step of executing instructions to display a report can include executing instructions to cause a list containing a plurality of links to be displayed, each displayed link representing a test and each displayed link being operable by a user to display a result of the test.

In such embodiment or other embodiments, the tests represented by the plurality of links can be obtained from at least two different data sources.

In a particular embodiment, the method may permit a medical professional to review each selected test result and the method may require approval of the selected test result prior to collecting the data from the selected test result.

### BRIEF DESCRIPTION OF THE DRAWINGS

FIG. 1 is a schematic diagram illustrating a medical information processing system in accordance with an embodiment of the invention.

FIG. 2 is a schematic diagram further illustrating a medical information processing system in accordance with an embodiment of the invention.

FIG. 3 schematically illustrates a screen display of a summary report according to an embodiment of the invention.

FIG. 4 is a flow diagram schematically illustrating a method of generating a report according to an embodiment of the invention.

FIG. 5 schematically illustrates a screen display for entry and selection of information on which a summary report is to be generated according to an embodiment of the invention.

FIG. 6 schematically illustrates a screen display of tests in a patient history.

FIG. 7 schematically illustrates a screen display depicting operation in accordance with a collaborative review and revision facility in accordance with an embodiment of the invention.

FIG. 8 schematically illustrates a screen display depicting further operation in accordance with a collaborative review and revision facility in accordance with an embodiment of the invention.

### DETAILED DESCRIPTION

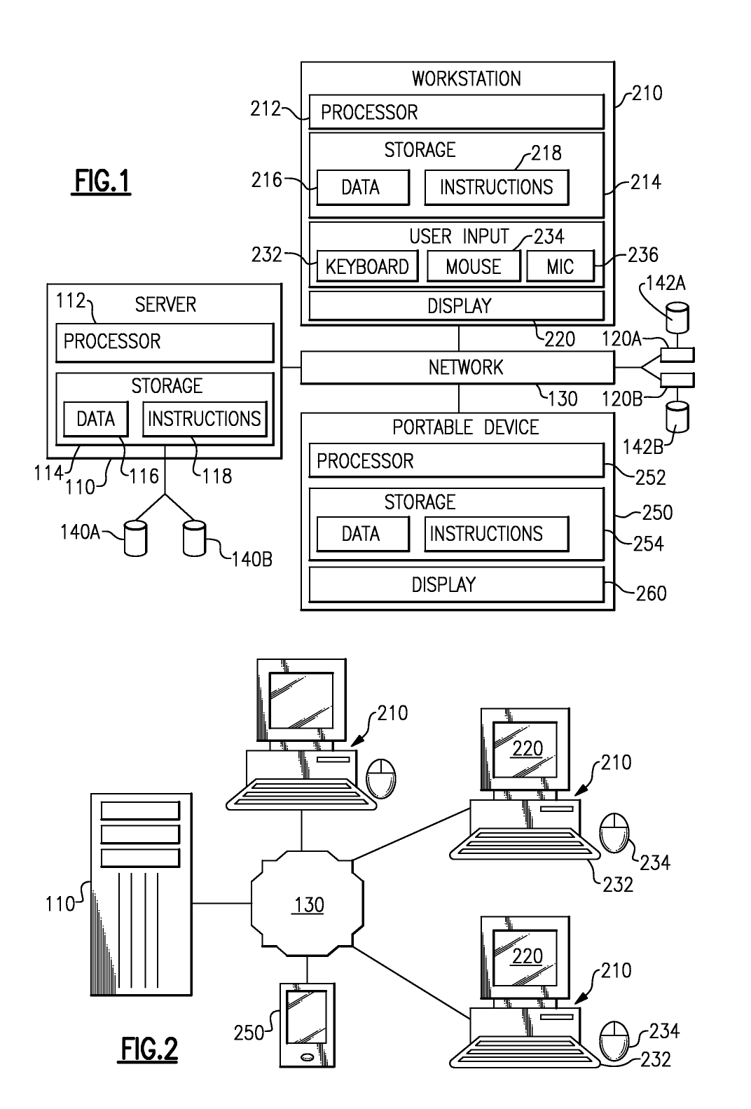

As shown in FIGS. 1 and 2, a medical information processing system can include a computer or information processing system 110, for example, a computer having a processor 112 that may include one or more microprocessors. The computer 110 may function as a server to serve data and instructions to other computers. Storage 114 is available for storing and retrieving information used by the processor. For example, storage 114 may be used to store data 116 and instructions 118 which are executable by the processor. Storage can include, for example, one or more of various magnetic, solid-state or optical drives, etc., for read-write access to data and instructions. The storage can also include one or more various portable memory media which can be read-write type, read-only type or combination type (e.g., a type of medium designed to be written only once but read many times), which can be recorded or read by electrical, magnetic, or optical means. For example, the storage can include an external memory drive or miniature memory card, e.g., SD card or drive, a compact disc (“CD”) or CD-ROM, digital versatile disc (“DVD”), magnetic tape media, etc., which are easily and readily interchangeable with other similar media, and on which data or instructions or both can be recorded, read and, in some cases, executed by computer 110. The server 110 can be connected to additional storage 140A, 140B, which can be locally connected thereto. The additional storage can house one or more repositories of data, e.g., sources of test data such as one or more databases which track orders of tests and the results which are produced by the tests.

The instructions 118 can be any instructions which are executable by the processor, such as machine language instructions, or can be in any computer language such as source code which is compiled in advance of execution or interpretable code which is interpreted during execution. The data can be handled, i.e., written to storage or retrieved therefrom or modified based on the execution of the instructions 118 by the processor. Although the storage 114 is shown together with processor 114 in computer 110, the storage may or may not be housed together with the processor in the same physical unit.

In one example, networking equipment 130 (hereinafter, “network”) can be used to facilitate communication between the computer 110 and a plurality of auxiliary servers 120A, 120B, to which additional databases can be accessed in storage 142A, 14B. The network can also connect the server with one or more workstations 210, as seen in FIG. 2. The three workstations 210 shown in FIG. 2 are merely illustrative, as there can be fewer or more workstations capable of connecting to a server 110 or to each other through a network 130. The network 130 can include one or more types of networks, such as, but not limited to: an enterprise network for the primary use or control by a particular organization, an intranet, i.e., a non-public network operating in accordance with the communication protocol known as Internet Protocol, or can be another type of a private or virtual private network, etc. The network 130 can include portions extending within a public network such as the Internet. In such case, provisions can be made for secure connections through the Internet to satisfy security and quality-of-service goals. Communications between nodes can be facilitated by any of a variety of network communication protocols, such as, without limitation, wired or wireless communication protocols.

Like computer 110, workstations 210 typically include a processor 212 (FIG. 1) and are capable of storing and retrieving data 216 and instructions 218 from associated storage 214 which may be housed together with the processor or separately therefrom. The workstation typically includes a display 220, e.g., a screen capable of electronically displaying still or moving images or both, which is capable of displaying information to a user in a form readable or recognizable by the user. Devices such as a keyboard 232 and a mouse 234, trackball or other pointing device typically are provided for registering user input. The display, keyboard, mouse (or both) can together facilitate inputting of user information through a graphical user interface (“GUI”) such as a Windows® operating system-enabled display (Windows is a registered trademark of Microsoft Corporation). For example, user input may be of a type which causes the display of information presented to the user at a particular location on the screen to be modified when the user selects the location using a mouse or other pointing device.

A portable computing device 250 (FIGS. 1-2), e.g., typically a handheld computer such as a personal digital assistant, e.g. Blackberry type device, or cellular phone type device, which may have a wireless interface or a wired (contact-based) interface may also be provided which can connect with computer 110 or a workstation 210 through network 130. Like computer 110, the portable device 250 can have a display 260 for presenting information to the user and typically has one or more of a keyboard (not shown) or keypad (not shown) and pointing device (not shown) for registering user input therewith. Like computer 110, portable device 250 has a processor 252 and storage 254 for the storage of instructions for execution by processor 252 to retrieve, store or modify data. Although some functions may be indicated below as being performed on a server and other functions may be indicated as being performed on a workstation, various aspects of a system and method may be implemented by a single computer.

A specific example of a medical information processing system which can be used to generate a report summarizing a disease state of a patient will now be explained with reference to the following description and accompanying figures. A method of generating a report can include a step of generating a template which includes a set of rules for constructing the report. At least one function of the rules of the template is to select one or more data sources from a plurality of available data sources. The data sources can be structured. For example, the data sources can contain data and other information which identifies the content or purpose of the data. In a particular example, a data source such as a database can include particular data fields of data (i.e., “data fields”) and a set of field identifiers which indicate the type of data that each data field contains. In a specific example, a database can include structured data such as patient information and test results. As an example of structured data, a data field can contain the family names of patients, and the data field can have a corresponding field identifier of “Family_Name” or “Last_Name”. In one example, the “Family Name” data field of a patient record stored in the database contains the entry “Johnson”, the family name of the patient.

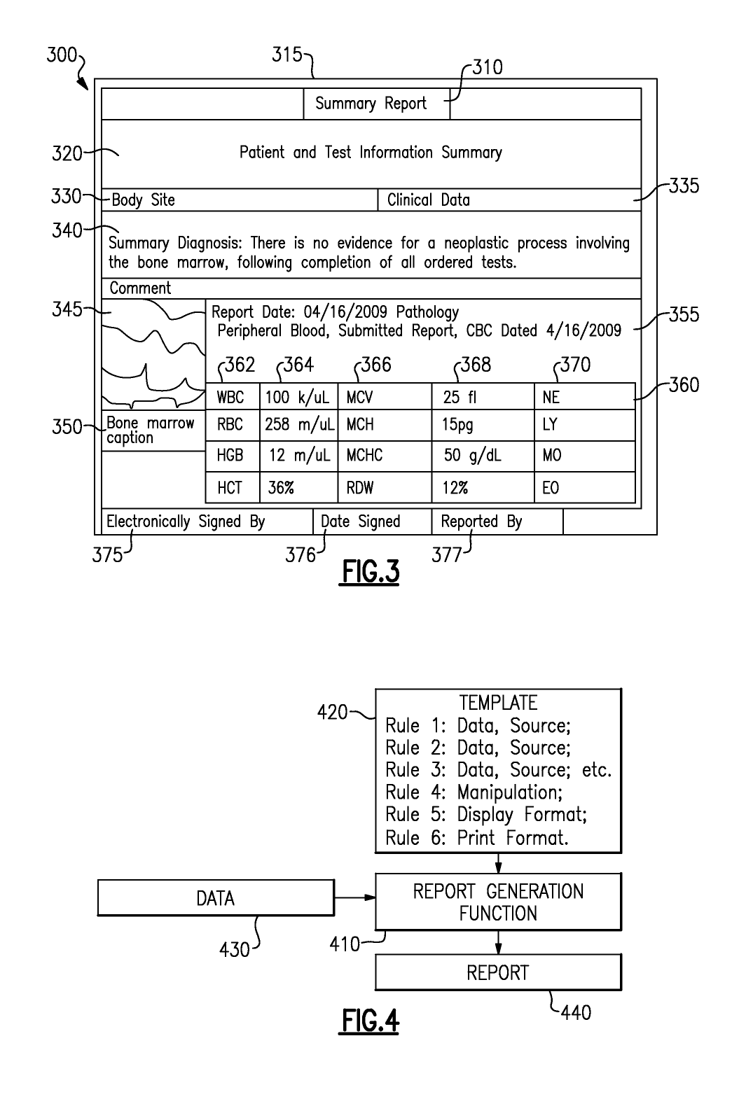

FIG. 3 schematically illustrates a screen display of a summary report 300 which can be generated using an “Interpretive Workstation” according to an embodiment of the invention. As seen in FIG. 3, the screen display can include several distinct sections. Because the content of the summary report can include a plurality of sections containing the results of tests performed according to a plurality of different test technologies, the summary report can be called a “multi-technology test review”. One function of the Interpretive Workstation can be to generate a unified summary report from results of tests performed according to a plurality of different test technologies. In that way, a unified summary report relating to the different tests can be generated and reviewed, for example, by a pathologist who ordered the tests and evaluates the results therefrom, even though the scheduling and tracking of particular tests can be performed on different computer systems which can use different ways to track the tests, collect test results or report the test results. Therefore, even though particular tests may have different data collection, tracking and reporting requirements, and the data relating to them can differ, the Interpretive Workstation can assemble a summary report containing at least some of the results reported in the different tests.

As seen in FIG. 3, a header 310 on the screen, which can be at or near a top edge 315 of the screen, can identify the type of information displayed on the screen. For example, as seen in FIG. 3, a header can identify the screen as a “Summary Report”. In another embodiment, the header can be displayed at a location that is not at a top edge of the screen. In addition to the header, the screen 300 can display content of the summary report. The screen can contain a section 320 listing patient identification information, e.g., the patient's given and family names, the patient's date of birth, age, sex, and a patient identification number. In one embodiment, the data relating to the patient can be obtained by presenting a patient identifier such as medical record number (MRN) to query a data source such as a “master patient index” (MPI) for the provider organization, using a patient identifier such as which is required within the provider organization to uniquely identify the patient. The section 320 may also list the names of a treating physician, a hospital, hospital identification number, and identification of a test specimen to which the report relates.

The screen can also include a section 330 which identifies a “Body Site” or location of the patient's body from which a test specimen was collected. A section 335 bearing the header “Clinical Data” can contain data that is entered for the test specimen when accessioning the original specimen. For example, this section 335 can indicate that a test was ordered because the patient presented with symptoms of extreme fatigue and weakness. This in turn justifies the reasons the component test(s) are ordered and performed. Another section 340 of the report can contain a statement summarizing the patient's diagnosis. For example, the section 340 can include a header “Summary Diagnosis”, and a statement which can relate to a test or a plurality of tests which are ordered to determine whether a particular suspected medical condition exists. Thus, the statement can indicate whether or not the test result is consistent with a suspected medical condition. The statement typically will be entered by a medical professional, e.g., physician, responsible for the patient. For example, screen 340 contains a statement indicating “There is no evidence for a neoplastic process involving the bone marrow, following completion of all ordered tests.”

In addition, the summary report can contain one or a plurality of images which relate to the testing to which the report relates. For example, as seen in FIG. 3, the report can contain an image 345 embedded therein which is produced pursuant to a test order that is summarized on the report. In this case, the image 345 shows an image of bone marrow taken pursuant to the test order. The image also bears a caption “Bone marrow caption” to indicate the content of the image.

As further seen in FIG. 3, the summary report can also contain data indicating the values of particular tests conducted pursuant to a test order that is summarized on the report. For example, as seen in FIG. 3, a caption 355 refers to a specific test conducted on peripheral blood, and the results of the test for a variety of parameters are detailed in a table 360 provided on the report. The table may contain a column 362 that indicates tested parameters, e.g., components of the peripheral blood, e.g., “WBC” (white blood cell count), “RBC” (red blood cell count), “HGB” (hemoglobin), etc. Another column 364 to the right of column 362 can contain quantities of the tested parameters and the units in which the quantities are expressed. For example, with respect to “RBC”, the red blood cell count, a test result of “258 M/uL” indicates a count of 258 M (approximately 258 million) red blood cells per microliter of the peripheral blood. Another column 366 can indicate other tested parameters, e.g., components of the peripheral blood which are tested, these being listed as “MCV”, “MCH”, etc. Another column 368 to the right of column 366 can contain quantities of the tested parameters, and the units in which the quantities are expressed. Still another column 370 can indicate other tested parameters, e.g., components of the peripheral blood which are tested, these being listed as “NE”, “LY”, etc.

As indicated above, the report can be prepared and signed by a physician or other authorized medical professional. The screen on which the report is displayed can also display an area 375 bear a caption “Electronically Signed By” and indicating the identity of the authorized physician/professional who signed the report. The screen can also contain an area 376 bearing a caption “Date Signed” and containing information indicating the date on which the report was signed. The screen may also contain an area 377 bearing the caption “Reported By” with information listing a name of a physician or other authorized medical professional who initiated or dictated the summary report. For example, the summary report may be created or initiated by a resident or fellow in a teaching institution and be assigned to a senior pathologist for final review and signoff. The pathologist can then finalize the summary report which can contain the resident or fellow's conclusion and other data which relates thereto or supports the summary report. The area 377 captioned “Reported By” can identify the person, e.g., the resident, fellow or other physician, who forwards or otherwise renders the initial revision of the summary report, and who then submits the report to the senior pathologist.

FIG. 4 illustrates a functionally organized flow diagram for generating a summary report 440. As depicted therein, a report generation function 410, containing a set of computer-readable and executable instructions, typically operates using a rules-based template, or “template” 420 to gather data 430 from one or a plurality of data sources. The template 420 directs the generation function 410 to collect data from a selected one or selected ones of the available data sources. The template 420 can also direct the collection of selected data from the selected data source or sources.

Specifically, the template can contain a plurality of rules, e.g., “Rule 1”, “Rule 2”, etc. as seen in FIG. 4. A rule, for example, may simply select particular data for collection, and select a particular source of data from which to collect the data. In FIG. 4, Rule 1, Rule 2 and Rule 3 have this function. A particular rule, e.g., Rule 4, may specify manipulation of data being assembled into the report. For example, a rule may require that a certain “canned text” be inserted into the report if a component test is “abnormal”. For example, if a test result indicates a tested quantity is 6.0 g/dL and the normal range of the test quantity to 3.0 to 5.0 g/dL, then a rule of the template may automatically insert the desired text. The template may also contain a rule, e.g., Rule 5, which controls a display format for displaying the summary report on a screen. The template may also contain a rule, such as Rule 6, which controls a print format by which the summary report is to be printed.

One of the powerful aspects of using a template to direct the selection of data sources, specific fields of data therein, the manipulation of data, and its formatting is that the template can be changed easily. Indeed, a person unskilled in computer programming can change the template. Typically, the template can be created or changed by a privileged user of the medical information processing system who retains a privilege above that of an ordinary user. The privileged user can be a responsible physician, e.g., a pathologist who is responsible for the content of a summary report that can be generated using the template. Moreover, in one embodiment, the privileged user can select the data sources and data from each data source in a natural and intuitive manner, such as by using a pointing device and an interactive screen display, e.g., a screen presenting a plurality of prompts in a format of a graphical user interface (“GUI”). For example, the screen may present one or more prompts to the privileged user for creating or modifying a rule that governs the data sources from which data is to be collected for inclusion in the summary report. The responses by the privileged user can then be used to select, set up or alter a rule of the template. In one embodiment, responses to other prompts can be used to select or otherwise determine a rule on how data to be assembled in the report is to be manipulated. In one example, one or more prompts on a screen can allow the privileged user to select, create or modify a rule which governs how the summary report is to be formatted when printed or displayed on a screen. In addition, based on the rules it includes, the template can generate canned text such as a preformatted text string which may include the name of the physician who is signing out the repot, as well as a time, date, timestamp, date of test result, test result values, and a set of draft interpretative comments for the physician to review, revise or accept.

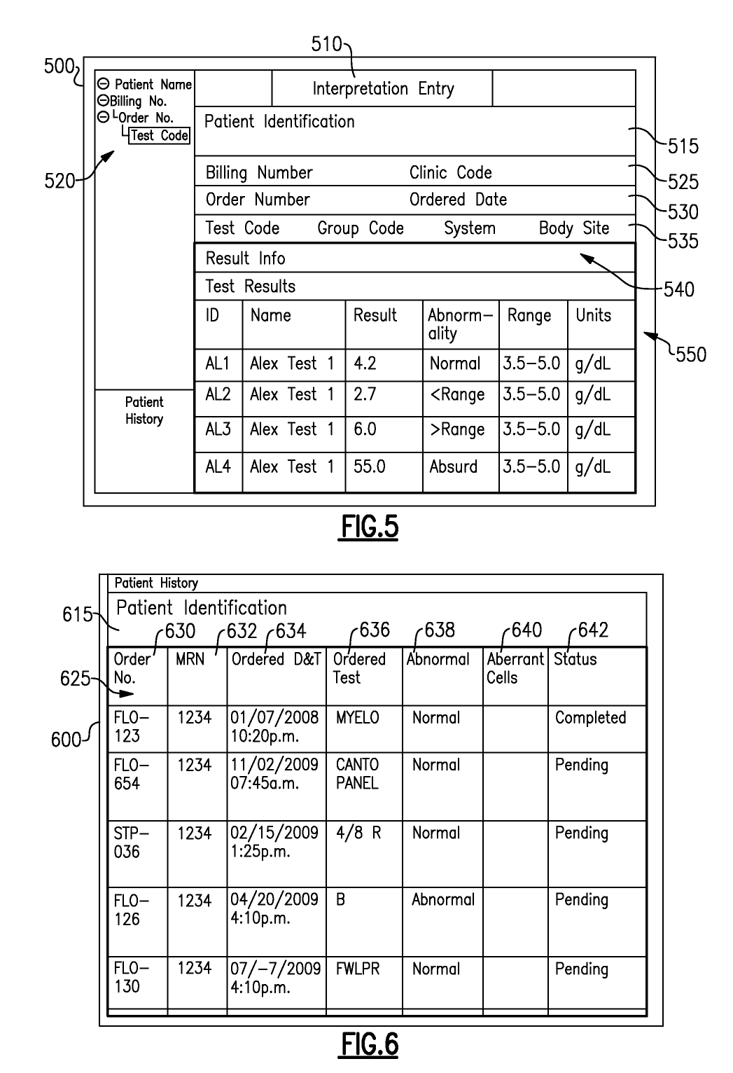

A process of reviewing data sources and data for inclusion in the summary report is illustrated in greater detail in FIGS. 5 and 6. FIG. 5 depicts an “Interpretation Entry” screen 500 which can be displayed when the responsible physician selects the results of one or more tests for inclusion in the summary report (FIG. 3). The Interpretation Entry screen 500 allows the physician to select an appropriate test result to review by interaction with a graphical user interface (“GUI”) type screen. For example, the physician can select a test result to review by manipulating a location of a cursor on a screen, such as by a pointing device (e.g., a mouse or trackball) to select a test result from a list of test results displayed on the screen 500. FIG. 6 depicts the display of previous tests for the patient that are not included in the current order. This allows the physician, e.g., pathologist, to also review prior tests, typically all prior tests, for a comprehensive view of the progression or regression of the disease state.

The Interpretation Entry screen 500 can be organized in sections. The screen can have a header 510 which identifies the screen by a name such as “Interpretation Entry”. The screen can also include a section titled “Patient Identification” 515 which contains information which identifies a particular patient, such as by Medical Record Number (“MRN”), given name, family name, and date of birth. The Patient Identification section 515 may contain further information concerning the patient such as age, sex, or race. The information which is displayed on the screen can match the current location highlighted in a tree 520 displayed at another area of the screen, e.g., a frame area of the screen. The items listed in the tree 520 can include a “Patient Name”, e.g., the given name and family name of a patient, as well as a “Billing No.”, which can be an actual billing number used track services performed for the patient and bill the patient. The physician can input information to a selection screen (not shown) other than screen 500 in response to prompts for Patient Name and Billing No. and the results retrieved thereby can be displayed on screen 500. The selection screen (not shown) can also permit a particular order number to be selected for display from among a plurality of order numbers corresponding to orders of tests performed for the patient. The test results displayed on screen 500 can then be limited to such order number, and the value of the Order Number can be displayed in a screen area 530 adjacent to the caption “Order Number”. In the particular example illustrated in FIG. 5, a particular value of “Test Code” may be highlighted in the tree 520, indicating that the results corresponding to such test code are selected for display by the physician. The results corresponding to the selected test code can then be shown in a table area 550 of the screen 500.

Typically, the billing numbers are not restricted to those of a particular provider organization. Occasionally, testing can be performed on the patient's behalf at a plurality of provider organizations. Therefore, the ability to locate and retrieve data from other data sources, e.g., from sources other than the immediate provider organization, can prove useful. Moreover, the order numbers and test codes which are available for selection are not limited to a particular test technology. These items can relate to a plurality of different test technologies and can relate to testing for which results are normally managed and stored separately from other test results. One feature of such function is an ability for a screen display (such as seen in FIG. 5) to permit a user, e.g., a physician, to review a list of tests performed and the results thereof for a particular patient, regardless of differences in the test technologies to which the tests belong.

In an example of operation, the physician can select a particular patient for which to prepare a summary report, by inputting a name of the patient or other identifying information, e.g., an MRN, etc., to a prompt (not shown) on a search selection screen (not shown). The physician can then select a billing number for the patient. Selecting a billing number can help confirm the identity of the patient selected by the physician. Often, there will be only one billing number for the patient because the billing number is required to be unique within a provider organization. However, if tests are performed both within and outside of the provider organization, it is possible that more than one billing number can correspond to the same patient. An order number and a test code may also be inputted on the search selection screen to further restrict the test results to be reviewed by the physician, if desired.

The Interpretation Entry screen 500 of FIG. 5 can then display the results of tests selected using the search selection screen in a section captioned “Result Info” 540 and in a table captioned “Test Results” 550. The screen 500 can display the patient's name and other information regarding the selected patient in the Patient Identification section 515 of the screen. A billing number and a code for a provider clinic can be listed in section 525 of the screen adjacent to the headings “Billing Number” and “Clinic Code” therein. The Order Number and Ordered Date can be displayed adjacent to the captions therefor in section 530 of the screen. Other information including a “Test Code” corresponding to the tests performed can be displayed in a section 535 of the screen.

In a particular embodiment, the execution of instructions by a processor causes data to be gathered conditionally from a plurality of structured data sources in accordance with the rules of a template. In such case the gathered data can relate to medical tests of a patient which are performed in accordance with one or more orders of tests. Thus, in such embodiment, one or more of the rules of the template can select first data that relates to a result of at least one medical test conditionally based on one or more conditions being true. For example, the first data can be selected for inclusion in the report based on the existence of a given medical condition of the patient which is expressed by a clinical indication. As a specific example, first data such as results of peripheral blood tests which are useful in diagnosing a particular condition can be selected when the medical condition is chronic obstructive pulmonary disease (“COPD”), as expressed by a clinical indication of the patient having difficulty breathing. In another example, the template can conditionally select first data that includes cytogenetics data when the medical condition of the patient is of a predetermined class of medical conditions. Such first data can then be presented on the report.

In another example, particular first data can be conditionally selected by the template when an out-of-range result is obtained on at least one of the plurality of medical tests. Thus, if the result of a particular test is out of range, then additional data, such as, for example, data obtained from one or more tests other than the present medical tests can be conditionally selected in accordance with a conditional rule of the template. In a particular example, first data can be selected based on an out-of-range result obtained on another medical test of the patient, wherein such medical test is other than the plurality of medical tests of the present order. Such additional data can be considered by the physician and can be presented on the summary report.

In a further particular example, the first data can be conditionally selected based on a marker result, e.g., a biomarker such as a karyotype, or haplotype, of a flow cytometry test being outside of a predetermined range. In such case, the first data can include a karyotype image or can include an interpretative textual segment specific to the marker result. In such case, the executing of instructions can generate the report to include the karyotype image and results of the flow cytometry test in a textual segment in a predetermined location of the report.

In another example, particular first data can be conditionally selected by the template when an out-of-range result is obtained on a medical test of a probant who is a person other than the patient. In one example, the probant may be a person related to the patient or closely connected to the patient, such that the medical condition of the probant can have a bearing upon the medical condition of the patient. In a particular example, the probant can be someone from whom the patient has received or is to receive an organ, tissue or blood, for example. The template can conditionally select particular first data for inclusion on the report or for consideration by the attending physician in accordance with a rule of the template. Such additional data can be considered by the physician and can be presented on the summary report.

In another example, particular first data can be conditionally selected in accordance with a rule of the template based on the existence of a given medical condition in a pedigree of the patient. For example, particular data which could be beneficial to diagnosing a medical condition relating to the heart of the patient can be selected conditionally by the template for inclusion in the report when the pedigree of the patient contains at least one member who has or has had a medical condition relating to the heart.

In yet another example, particular first data can be conditionally selected by the template based on the existence of a given medical condition in a pedigree of the patient and an out-of-range result obtained in at least one medical test. In a particular example, the first data can be conditionally selected based on the existence of the given medical condition in the pedigree when an out-of-range result is obtained on at least one medical test of the patient. In a particular example, the first data may be conditionally selected based on the occurrence of the medical condition in the pedigree and an out-of-range result in a predetermined at least one of the medical tests. In another particular example, the first data can be conditionally selected based on the occurrence of the medical condition in the pedigree and an out-of-range result obtained in at least one medical test of a probant, where the probant is a person other than the patient.

FIG. 6 depicts and example of a Patient History screen 600 displaying an expanded table of information concerning a plurality of test orders of previous testing performed for the patient. In FIG. 6, the Patient Identification section 615 within the Patient History screen can match the section 515 of FIG. 5 which bears the same caption. For example, such section 615 can contain information identifying the patient by name, MRN, date of birth, and other attributes, e.g., age, sex and race. In the table section 625 of the screen, results of each test order can be listed in a respective row of the table. The columns of the table can be used to organize the data fields that are subject to vary. For example, in FIG. 6, the columns of the table are provided respective column headers: “Order No.” in column 630, “MRN” in column 632, “Ordered D&T” (ordered date and time) in column 634, “Ordered Test” in column 636, “Abnormal” in column 638, “Aberrant Cells” in column 640 and “Status” in column 642.

Within each column, variable data can be displayed. In FIG. 6, test order numbers are displayed in the different cells of column 630. The presence of an identical MRN “1234” in all cells of column 632 can indicate to the user that all the orders in the table relate to the same patient. The test orders can relate to different tests conducted, which are listed by short abbreviations of descriptive text, e.g., “MYELO, “CANTO PANEL”, “4/8 R”, “B” and “FWLPR” as indicated in column 636, and the tests are ordered at dates and times as indicated in the column captioned “Ordered D&T” 634. The status of each order as containing a “Normal” or “Abnormal” result can be indicated in the cells of column 638. In addition, the status of each order as being “Completed” or “Pending” can be indicated in the cells of column 642. Also, the presence of any cells identified as being “Aberrant” during the test can be indicated in the cells of column 640. From the list of displayed test orders in screen 600, the user, e.g., a physician can select a relevant order number, such as by interacting with the screen 600 using a pointing device, e.g., a mouse.

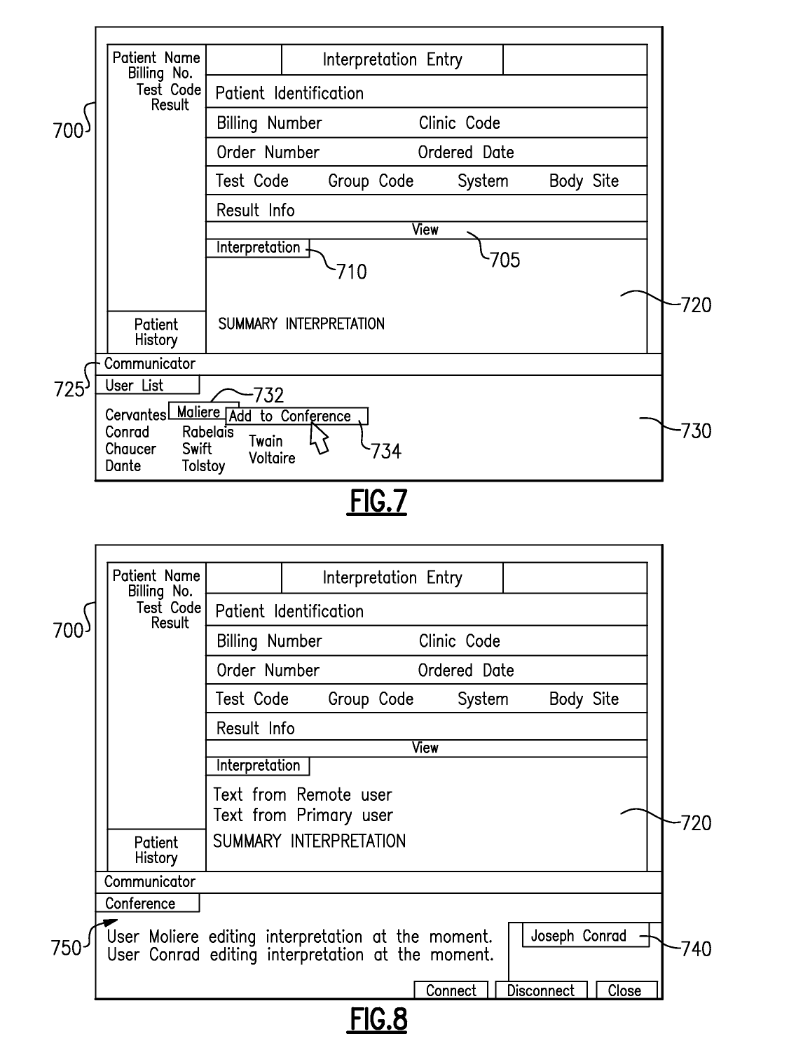

FIG. 7 illustrates a screen 700 which depicts operation according to another embodiment of the invention. This facility permits collaborative review and revision of a document by a plurality of users located at a plurality of respective information processing systems, e.g., client terminals, workstations or portable devices. Using such facility, users such as physicians who are working together in handling, i.e., diagnosing or treating, a patient can consult together as to the content to be incorporated in a summary report (FIG. 3), for example. The facility permits each user to view the same screen containing the same information simultaneously, even though the users are located at information processing apparatuses which are remote from each other. The facility causes the information that is displayed on a primary screen to a first user at a first information processing apparatus, e.g., a workstation also to be displayed simultaneously on a screen of another workstation or other information processing apparatus to another user. The facility also permits either the first or second user to edit the information displayed at that user's screen, and also causes the changes made by that user to be reflected on the screen of other information processing apparatuses or workstations which are participating in the collaborative review. Management of control over which user is currently allowed to edit the editable information is provided through tokens, of which two types are provided, which will be described in greater detail below.

Referring to FIG. 7, a collaborative review session or “conference” can begin by one user opening a stored document available to the user via the user's information processing system. In the example seen in FIG. 7, the user opens a summary report document at an “Interpretation Entry” screen thereof, similar to the view seen in FIG. 5. All elements depicted in FIG. 7 are the same as the like labeled elements depicted in FIG. 5 unless otherwise noted. The user has opened screen 700 to a “View” 705 facility and an “Interpretation” 710 tab, such that an editable “interpretation” area 720 is opened. In the interpretation area 720, the user is able to input a summary diagnosis, such as will be displayed at screen area 340 of the summary report screen 300 (FIG. 3). The user is also able to record notes and perform operations, e.g., preliminary calculations, which can help a user such as physician to determine the final diagnosis. As seen in FIG. 7, the words typed in this area 720 can relate to “Summary Interpretation”, and can include information inputted by the user, such as a string of characters or words, for example.

By selecting an appropriate button or other prompt on the screen, the user can then invoke the collaborative review facility, which is apparent in FIG. 7 because a symbol or word “Communicator” is displayed as a header 725 therein. Invoking the facility can cause a list of users to be displayed, such as a list of users with whom the user has a working relationship. In one embodiment, the list can be retrieved from storage. For example, in FIG. 7, the available users are listed in a screen area 730 as “Cervantes”, “Conrad”, “Chaucer”, “Dante”, “Moliere”, “Rabelais”, “Swift”, “Tolstoy”, “Twain”, and “Voltaire”. The user may be one of the users shown on the displayed list; for example, the user may have the name Joseph Conrad and whose name appears in the list as “Conrad”. The user can select users from the displayed list. For example, FIG. 7 depicts an operation in which the user selects another user “Moliere” 732, and selects the function “Add to Conference” 734, such as using input from a pointing device (e.g., mouse). The user can select a third, fourth or still other users for the conference. There is no implicit restriction on the number of users who can participate in a conference using this facility. When the first user has selected another user to participate, the facility can then establish communication between the information processing apparatuses, e.g., workstations of each user to permit the simultaneous display of information on the screens of both users, and permit editing of the editable information therein by the user-participants to the conference.

FIG. 8 illustrates use of the facility to edit information displayed on an editable area 720 of the screen. The identity (“Joseph Conrad”) of the primary user, that is, the user whose screen is displayed in FIG. 8, is stated in a screen area 740 provided for that purpose. As seen in FIG. 8, the screen 700 further includes buttons “Connect”, “Disconnect” and “Close” used to control user participation, e.g., link-up, to the conference.

FIG. 8 depicts that the editable screen area 720 has been altered. At least the editable screen area 720 is “shared”, i.e., simultaneously displayed at the information processing apparatuses of other user-participants to the conference. The shared screen area 720 can look exactly the same on all the information processing apparatuses of all the user-participants to the conference. Using the facility, the remote user has added text represented in area 720 as “Text from Remote user”. In addition, the primary user has added text represented in area 720 as “Text from Primary user”. In addition, the area 750 of the screen labeled “Conference” can make a running record of which user or users are editing the opened document, e.g., report. Here, the screen area 750 records “User Moliere editing interpretation at the moment.” and at another time “User Conrad editing interpretation at the moment.” The screen area 750 can record this information in a chronological order, user-determined order, or both, such that a user of the facility can determine which changes to the opened document were made earlier than other changes, and which user made the changes.

The ability to control a privilege of editing the information in the opened document to participants of the conference is provided through use of tokens, of which two types can be used. A user who sets up or arranges for the conference can acquire a “leader” token as a user who has a standing privilege to edit the document. Such user can pass the leader token to another participant of the conference to permit the token's recipient to edit the document. The recipient then becomes a new owner of the leader token, effectively making the new owner the new leader. Then, the new leader can have control over the leader token until or unless the new leader passes such token to another user who would then become an even newer leader.

Another way a user can acquire a privilege to edit the information on the opened document is by obtaining a volunteer token which can be available to all user-participants of the conference. The use of a volunteer token may be implicit in a participant's editing of the document. Stated another way, the user may not need to know that there is a volunteer token, and the user may not need to take a separate action to acquire the volunteer token before using it. For example, in one embodiment, any user can “grab” or take control of and hold the volunteer token, just by attempting to edit the document. Such user then can retain ownership of that token as long as such user continues to actively use the editing privilege. However, once the user no longer actively edits the document, the edit session can time out, in which case the volunteer token can automatically revert to unassigned status, making the token available for any user to take control of again.

Editing of the document by user-participants to the conference is limited to a user at a single one of the information processing systems at a time. Thus, although at any given time, there can be a leader token and a volunteer token controlled by two different users, the facility can restrict editing of the document to a single one of the token-holding users at one time. Thus, the facility can restrict editing such that only the information processing apparatus belonging to the user who is actively editing the information can display the information in a form that accepts user input for editing the displayed information. On the other hand, the facility can restrict use of other information processing apparatuses, e.g., workstations (of other participants in the conference) such that the information displayed at the other information processing apparatuses is displayed in non-editable (i.e., “read only”) form, when the one participant is actively editing the information therein. Typically, as soon as one participant in the conference starts to edit the opened document, the document privileges of other participants are reduced to read only. Then, after such participant has stopped actively editing the document for some period of time, the document privileges of participants revert back to read and write, i.e., being that the volunteer token then is available again for any one of the participants to grab and use to edit the document.

While the invention has been described in accordance with certain preferred embodiments thereof, those skilled in the art will understand the many modifications and enhancements which can be made thereto without departing from the true scope and spirit of the invention, which is limited only by the claims appended below.

1. An information processing system, comprising:
a processor; and
instructions executable by the processor to perform a method, the method including:
gathering data conditionally from a plurality of structured data sources in accordance with rules of a template, the gathered data relating to a plurality of medical tests of a patient performed in accordance with one or more orders of tests, at least one of the rules selecting first data relating to a result of at least one of the medical tests conditionally based on at least one of: the existence of a given medical condition of the patient expressed by a clinical indication, an out-of-range result obtained on at least one of the plurality of medical tests, an out-of-range result obtained on another medical test of the patient being a medical test other than the plurality of medical tests, an out-of-range result obtained on a medical test of a probant being a person other than the patient, the existence of a given medical condition in a pedigree of the patient, or the existence of a given medical condition in the pedigree of the patient and an out-of-range result obtained in at least one medical test; and
generating a report in accordance with the gathered data and at least one rule of the template, the report summarizing a disease state of the patient.

2. The information processing system as claimed in claim 1, wherein the conditionally gathering of data selects the first data based on the existence of a medical condition of the patient expressed by a clinical indication.

3. The information processing system as claimed in claim 2, wherein the conditionally gathering of data selects first data including cytogenetics data when the medical condition of the patient is of a predetermined class of medical conditions.

4. The information processing system as claimed in claim 1, wherein the conditionally gathering of data selects the first data based on an out-of-range result obtained on another medical test of the patient being a medical test other than the plurality of medical tests.

5. The information processing system as claimed in claim 4, wherein the conditionally gathering of data selects the first data based on a marker result of a flow cytometry test being outside of a predetermined range, wherein the first data includes a karyotype image and includes an interpretative textual segment specific to the marker result.

6. The information processing system as claimed in claim 5, wherein the generating of the report generates the report to include the karyotype image and results of the flow cytometry test in a textual segment in a predetermined location of the report.

7. The information processing system as claimed in claim 1, wherein the conditionally gathering of data selects the first data based on an out-of-range result obtained on a medical test of a probant being a person other than the patient.

8. The information processing system as claimed in claim 1, wherein the conditionally gathering of data selects the first data based on the existence of a given medical condition in a pedigree of the patient.

9. The information processing system as claimed in claim 1, wherein the conditionally gathering of data selects the first data based on the existence of a given medical condition in the pedigree of the patient and an out-of-range result obtained in at least one medical test.

10. The information processing system as claimed in claim 9, wherein the conditionally gathering of data selects the first data based on the existence of the given medical condition in the pedigree of the patient and an out-of-range result obtained in at least one medical test of the patient.

11. The information processing system as claimed in claim 10, wherein the conditionally gathering of data selects the first data based on the existence of the given medical condition in the pedigree of the patient and an out-of-range result obtained in at least one medical test of a probant, the probant being a person other than the patient.

12. A computer-readable storage medium having instructions recorded thereon which are executable by a processor to perform a method, the method comprising:
gathering data conditionally from a plurality of structured data sources in accordance with rules of a template, the gathered data relating to a plurality of medical tests of a patient performed in accordance with one or more orders of tests, at least one of the rules selecting first data relating to a result of at least one of the medical tests conditionally based on at least one of: the existence of a given medical condition of the patient expressed by a clinical indication, an out-of-range result obtained on at least one of the plurality of medical tests, an out-of-range result obtained on another medical test of the patient being a medical test other than the plurality of medical tests, an out-of-range result obtained on a medical test of a probant being a person other than the patient, the existence of a given medical condition in a pedigree of the patient, or the existence of a given medical condition in the pedigree of the patient and an out-of-range result obtained in at least one medical test; and
generating a report in accordance with the gathered data and at least one rule of the template, the report summarizing a disease state of the patient.

13. A computer-readable storage medium as claimed in claim 12, wherein the conditionally gathering of data selects the first data based on the existence of a medical condition of the patient expressed by a clinical indication.

14. A computer-readable storage medium as claimed in claim 13, wherein the conditionally gathering of data selects first data including cytogenetics data when the medical condition of the patient is of a predetermined class of medical conditions.

15. A computer-readable storage medium as claimed in claim 12, wherein the conditionally gathering of data selects the first data based on an out-of-range result obtained on another medical test of the patient being a medical test other than the plurality of medical tests.

16. A computer-readable storage medium as claimed in claim 15, wherein the conditionally gathering of data selects the first data based on a marker result of a flow cytometry test being outside of a predetermined range, wherein the first data includes a karyotype image and includes an interpretative textual segment specific to the marker result.

17. A computer-readable storage medium as claimed in claim 16, wherein the generating of the report generates the report to include the karyotype image and results of the flow cytometry test in a textual segment in a predetermined location of the report.

18. A computer-readable storage medium as claimed in claim 12, wherein the conditionally gathering of data selects the first data based on an out-of-range result obtained on a medical test of a probant being a person other than the patient.

19. A computer-readable storage medium as claimed in claim 12, wherein the conditionally gathering of data selects the first data based on the existence of a given medical condition in a pedigree of the patient.

20. A computer-readable storage medium as claimed in claim 12, wherein the conditionally gathering of data selects the first data based on the existence of a given medical condition in the pedigree of the patient and an out-of-range result obtained in at least one medical test.

21. A computer-readable storage medium as claimed in claim 20, wherein the conditionally gathering of data selects the first data based on the existence of the given medical condition in the pedigree of the patient and an out-of-range result obtained in at least one medical test of the patient.

22. A computer-readable storage medium as claimed in claim 21, wherein the conditionally gathering of data selects the first data based on the existence of the given medical condition in the pedigree of the patient and an out-of-range result obtained in at least one medical test of a probant, the probant being a person other than the patient.

23. A computer-implemented method of generating a report, comprising:
executing instructions by a processor to:
gather data conditionally from a plurality of structured data sources in accordance with rules of a template, the gathered data relating to a plurality of medical tests of a patient performed in accordance with one or more orders of tests, at least one of the rules selecting first data relating to a result of at least one of the medical tests conditionally based on at least one of: the existence of a given medical condition of the patient expressed by a clinical indication, an out-of-range result obtained on at least one of the plurality of medical tests, an out-of-range result obtained on another medical test of the patient being a medical test other than the plurality of medical tests, an out-of-range result obtained on a medical test of a probant being a person other than the patient, the existence of a given medical condition in a pedigree of the patient, or the existence of a given medical condition in the pedigree of the patient and an out-of-range result obtained in at least one medical test; and
generate a report in accordance with the gathered data and at least one rule of the template, the report summarizing a disease state of the patient.

24. A method as claimed in claim 23, wherein the conditionally gathering of data selects the first data based on the existence of a medical condition of the patient expressed by a clinical indication.

25. A method as claimed in claim 24, wherein the conditionally gathering of data selects first data including cytogenetics data when the medical condition of the patient is of a predetermined class of medical conditions.

26. A method as claimed in claim 23, wherein the conditionally gathering of data selects the first data based on an out-of-range result obtained on another medical test of the patient being a medical test other than the plurality of medical tests.

27. A method as claimed in claim 26, wherein the conditionally gathering of data selects the first data based on a marker result of a flow cytometry test being outside of a predetermined range, wherein the first data includes a karyotype image and includes an interpretative textual segment specific to the marker result.

28. A method as claimed in claim 27, wherein the generating of the report generates the report to include the karyotype image and results of the flow cytometry test in a textual segment in a predetermined location of the report.

29. A method as claimed in claim 23, wherein the conditionally gathering of data selects the first data based on an out-of-range result obtained on a medical test of a probant being a person other than the patient.

30. A method as claimed in claim 23, wherein the conditionally gathering of data selects the first data based on the existence of a given medical condition in a pedigree of the patient.

31. A method as claimed in claim 23, wherein the conditionally gathering of data selects the first data based on the existence of a given medical condition in the pedigree of the patient and an out-of-range result obtained in at least one medical test.

32. A method as claimed in claim 31, wherein the conditionally gathering of data selects the first data based on the existence of the given medical condition in the pedigree of the patient and an out-of-range result obtained in at least one medical test of the patient.

33. A method as claimed in claim 32, wherein the conditionally gathering of data selects the first data based on the existence of the given medical condition in the pedigree of the patient and an out-of-range result obtained in at least one medical test of a probant, the probant being a person other than the patient.

34. A method of collaboratively preparing a report summarizing a disease state of a patient, the method including using at least one processor to execute a plurality of instructions to perform steps comprising:
displaying first content on a screen at a first information processing system to a first user, the displayed content including editable information for selecting data sources and data for inclusion in the report;
permitting the first user to select at least one second user to review the content displayed on the screen;
establishing a connection between the first information processing system and at least one second information processing system;
displaying the first content on a screen at the at least one second information processing system to at least one second user;
permitting a user selected from the first user and the at least one second user to obtain a leader token;
permitting a user selected from the first user and the at least one second user to obtain a volunteer token; and
restricting editing of the editable information to only the user or the users who currently hold at least one of the leader token or the volunteer token, and restricting editing of the editable information to only one of the first or at least one second information processing apparatus at a time whose user holds such token, wherein the screen at any other information processing apparatus besides the one information processing apparatus being used to edit the editable information displays the editable information in a form non-editable by a user at the any other information processing apparatus.

35. The method as claimed in claim 34, wherein if the user who holds the volunteer token fails to use the volunteer token within a period of time having a predetermined duration, the token becomes available for any of the users to hold and use to edit the editable information.
